(19) United States
(12) Patent Application Publication
(10) Pub. No.: US 2013/0145818 A1
(43) Pub. Date: Jun. 13, 2013

(54) SENSOR UNIT UTILIZING A CLAMPING MECHANISM

(71) Applicants: Mario ALLGÄUER, Sirnach (CH); Philippe EHRISMANN, Uster (CH); Dario MEIER, Baden (CH); Joachim UFHEIL, Ihringen-Wasenweiler (DE); Marcus VAYHINGER, Liestal (CH); Francesca VENTURINI, Dubendorf (CH)

(72) Inventors: Mario ALLGÄUER, Sirnach (CH); Philippe EHRISMANN, Uster (CH); Dario MEIER, Baden (CH); Joachim UFHEIL, Ihringen-Wasenweiler (DE); Marcus VAYHINGER, Liestal (CH); Francesca VENTURINI, Dubendorf (CH)

(73) Assignee: METTLER-TOLEDO AG, Greifensee (CH)

(21) Appl. No.: 13/414,494

(22) Filed: Mar. 7, 2012

Related U.S. Application Data
(60) Provisional application No. 61/568,746, filed on Dec. 9, 2011.

(51) Int. Cl. G01N 7/00; F16L 41/00; G01D 11/24; F16L 23/00

(52) U.S. Cl. 73/23.2; 285/406; 285/206; 73/431

(57) ABSTRACT

A sensor unit for attachment to a container such as a bag or other vessel used to retain material includes a clamping mechanism for attaching the sensor unit to the container. The clamping mechanism may be configured to break or provide an indication that the connection between the sensor and container has broken that is visually detectable before a leak of material occurs or is detectable by a person visually monitoring the container or sensor. Such an indication can also indicate that the sensor was previously used and should not be used again for single use applications. Such a visual indicator is separate and different from seeing an actual leak and permits an event that may desterilize material within the container or lead to other problems to be corrected prior to use of a single use reaction system.

### CROSS-REFERENCE TO RELATED APPLICATION

The present application claims priority to U.S. Provisional Patent Application No. 61/568,746, which was filed on Dec. 9, 2011. The entirety of U.S. Provisional Patent Application No. 61/568,746 is incorporated by reference herein.

### FIELD

A single use sensor unit is disclosed that can be connected to a container, such as a bag, polymeric bag, or retention mechanism defined in shape by one or more walls used to define a shape or geometry of a retaining device sized to retain a material such as organic matter or a fluid. The sensor units may have one or more sensors used to monitor any of a number of parameters or properties of material stored in the container to which the sensor unit is attached.

### BACKGROUND

Known reaction systems are being partially or entirely replaced with single-use reaction systems in a number of industries such as the pharmaceutical industry, food chemistry industry or biochemical industry, for example. A single-use reaction system is designed to be disposed of after having been used once. Single-use objects used in such systems can include a container such as a bag or other retaining device that is structured from a polymeric material such as polyamide, polycarbonate, polyethylene, polyethersulphone, polypropylene, polytetrafluoroethylene, polyvinylchloride, cellulose acetate or ethylene vinyl acetate.

One example of a single-use reaction system is a bag reactor. It should be understood that a bag reactor is also known by other names, such as bioreactor, polymer reactor/bioreactor. A bag reactor can include one or more polymer bags connected to each other. Depending on the size, the bag reactors can be attached or set up in a support structure to support the bag reactors. Bag reactors are available in different volumes ranging from a few milliliters to several hundred liters and can be configured for batch or semi-batch processing.

Single-use reaction systems can be provided with one or more outlet conduits in order to remove material from the mechanism retaining the material of the reaction system, such as the bag of a bag reactor. Such systems may also include one or more inlet conduits for feeding material to the system. Often these inlets and outlets include ports. The ports may be defined or shaped by polymer flanges which are firmly bonded or otherwise attached to a retainer mechanism, such as a bag or other retainer structure used to retain material undergoing a reaction of the reaction system. The flanges may be structured to be flexible or rigid. If the flange is composed of a polymer material and the retainer mechanism is defined by a structure composed of a polymeric material, the flange may be firmly bonded by thermal welding, laser welding, ultrasonic welding or adhesion of the flange to the structure configured to retain material, for example.

Besides the transporting of materials, the ports may also be used for introducing sensors or measuring probes into the reaction system so that various parameters of the material retained therein can be determined or monitored in-situ. Examples of sensor units that may be attached to retainer structures such as polymeric bags or other containers may be appreciated from European Community Design Registration Nos. 001636432-0009, 001636432-0008, 001636432-0007, 001636432-0006, and 001636432-0005, which were registered and published in 2009 by the Office of Harmonization in the Internal Market of the European Union, which serves as the design and trademark registration office of the European Union.

Though reaction systems are often specified to be sterile, sensor units are not necessarily configured to permit the detection of an event that occurs that would act to prevent such sterilization or would desterilize the reaction system. For instance, if a seal or attachment of a sensor to a bag or other container used to retain material is damaged or comes loose it can be difficult to detect such an event until after a small leak of material may grow significantly enough to be seen or otherwise noticed. Such an occurrence, however, may desterilize the reaction system or reaction environment while it goes unnoticed. Such desterilization can negatively impact the reaction or may make the materials that are obtained from the reaction process unsuitable for their intended end use.

Moreover, single use sensors and the like may not have safeguards to ensure that a sensor or other element of a single use reaction system is not being reused improperly. As a result, such a single use system may be reused by accident. For example, known sensors do not include any suitable visual indicator that provides an indication that the sensor was previously used. The failure to provide such indications can result in a sensor designed or specified for a single use system being reused. Such reuse may prevent the sensor from being sterile for the second use and can therefore negatively affect the reaction system to which the sensor is utilized during its second use.

A new single-use sensor unit design is disclosed herein for incorporation into a single-use reaction system. An exemplary sensor unit as disclosed can be simply connected to a port of a bag or other container such that the connection of the sensor is impermeable to liquids even during transportation and during any reaction or other processing that may occur in the container. Further, such a connection can provide a suitable visual indication that the connection may be damaged or has previously been used that occurs before any leaking of material may occur, before any leaking of material may be detected, or before any second use of such a sensor when the sensor is designed for a single-use application.

### SUMMARY

A sensor unit sized and configured for attachment to a container is disclosed, comprising: a flange unit having an aperture, a base portion and a sensor retention portion, the base portion of the flange being attachable to the container, the sensor retention portion of the flange having at least one profile formed thereon; a measurement unit at least partially retained within the sensor retention portion of the flange unit, the measurement unit having at least one measuring element; a clamping mechanism having an opening for receiving a portion of the measurement unit, the clamping mechanism having at least one clamping element sized to engage with at least one of the at least one profile of the sensor retention portion of the flange unit such that the clamping mechanism ensures at least one of: (i) attachment of the measurement unit to the flange unit and (ii) enclosure of the at least one measuring element within at least one of the sensor unit and the container.

A disposable sensor port is disclosed including a bulkhead fitting for attaching to a flexible or semi-rigid wall of a container or a tubing, the disposable sensor port comprising: a sensor comprising a first end to be inserted through an aperture in the flexible or semi-rigid wall, a second end configured to be in contact with a cavity of the container or the tubing; a housing surrounding at least a portion of the sensor, the housing comprising a rigid polymeric bulkhead body; a first polymeric port place mounted on an external surface of the flexible or semi-rigid wall of the container or tubing; a second polymeric port plate mounted on an internal surface of the flexible or semi-rigid wall of the container or tubing, the first and the second polymeric port plates positioned such that the flexible or semi-rigid wall of the container or the tubing is sandwiched therebetween; and wherein the housing is seated through the first and second polymeric port plates, and a fastener is tightened against the first and second port plates and flexible or semi-rigid wall of the container or the tubing, to form a seal.

A disposable sensor port is disclosed including a bulkhead fitting for attaching to a flexible or semi-rigid wall of a container or a tubing, the disposable sensor port comprising: a sensor having a body comprising one or more substantially cylindrical-shaped portions and comprising a first end to be inserted through an aperture in the flexible or semi-rigid wall, a second end configured to be in contact with a cavity of the container or the tubing; a substantially cylindrical-shaped, threaded housing surrounding at least a portion of the sensor, the housing comprising a rigid polymeric bulkhead body having an outer surface comprising threads on at least a portion thereof; a polymeric port plate mounted on an external surface of the flexible or semi-rigid wall of the container or the tubing, the threaded housing seated through the polymeric port plate; and a bulkhead nut threaded onto the threaded housing and tightened against a sealing component and the port plate and flexible or semi-rigid wall of the container or the tubing, to form a seal.

A disposable port sized and configured for attachment to a container is disclosed, the disposable port comprising: a flange unit having an aperture, a base portion and a retention portion, the base portion of the flange unit being attachable to the container, the retention portion of the flange unit having at least one profile formed thereon; and a clamping mechanism, the clamping mechanism having at least one clamping element sized to engage with at least one of the at least one profile of the retention portion of the flange unit such that the clamping mechanism ensures at least one of: (i) attachment of a device to the flange unit and (ii) enclosure of the device within at least one of the disposable port and the container.

### BRIEF DESCRIPTION OF THE DRAWINGS

Exemplary embodiments of a sensor unit and methods of making such devices are shown in the accompanying drawings, wherein:

FIG. 1 is an exploded view of a first exemplary embodiment of a sensor unit sized and configured for attachment to a container such as a bag or other material retention device;

FIG. 2 is a bottom view of the first exemplary embodiment of the sensor unit;

FIG. 3 is a side view of the first exemplary embodiment of the sensor unit with a portion of the sensor unit cut away to provide a cross sectional view of the sensor unit;

FIG. 4 is an exploded view of a second exemplary embodiment of the sensor unit, wherein a portion of the sensor unit is cut away to provide a cross sectional view of elements of the sensor unit so that internal features of the sensor unit are illustrated;

FIG. 5 is a fragmentary view of the second exemplary embodiment of the sensor unit providing an enlarged view of a tail end portion of the measurement unit and flange unit portions of the sensor unit shown in FIG. 4;

FIG. 6 is a perspective view of an exemplary embodiment of a clamping mechanism, which may function as a retention cap, which is usable with embodiments of the sensor unit;

FIG. 7 is a perspective view of a third exemplary embodiment of a sensor unit;

FIG. 8 is a perspective view of a fourth exemplary embodiment of a sensor unit;

FIG. 9 is a cross sectional view of a fifth exemplary embodiment of a sensor unit; and

FIG. 10 is a cross sectional view of a sixth exemplary embodiment of a sensor unit.

### DETAILED DESCRIPTION

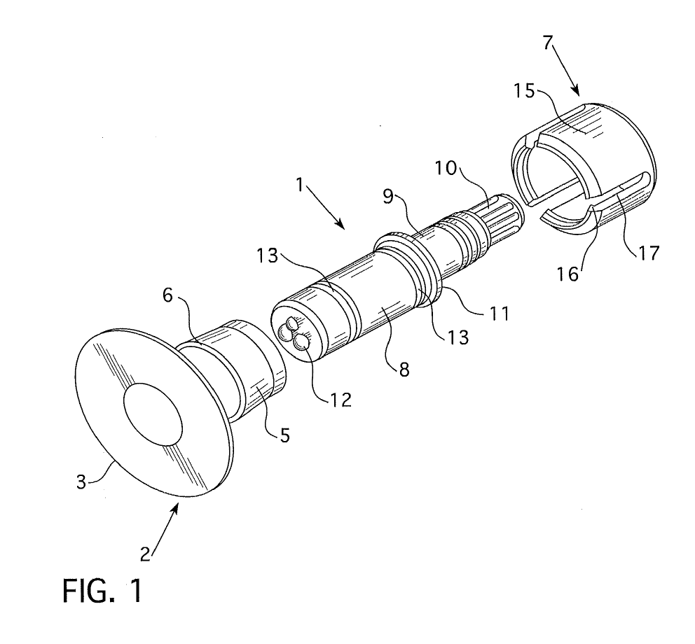

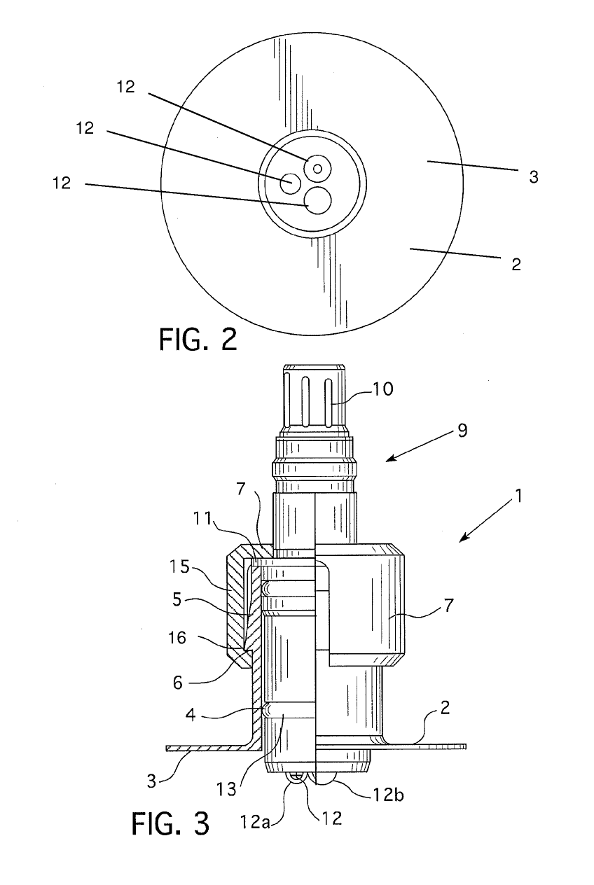

Referring to FIGS. 1-3, an exemplary sensor unit 1 is disclosed which can be sized and configured as a disposable sensor port for attaching to a flexible or semi-rigid wall of a container or tubing (e.g., a semi-flexible tube). The sensor unit 1 includes a housing that encloses or at least partially encloses a measurement unit 8 of the sensor unit 1. The sensor unit may be shaped to be generally cylindrical in shape, substantially cylindrical in shape, or may have other shapes or sized configurations to meet a particular design objective.

The housing may be, or may include a flange unit 2. The flange unit 2 includes a base portion 3 sized and configured for positioning against and attachment to a container or tubing, such as a bag of a bag reactor. The base portion 3 may have a hole, channel, or other aperture formed therein. In exemplary embodiments, the base portion can be considered a base flange used for securing the housing to the wall of a container or tubing. In some embodiments, the base portion 3 may be bonded to a wall of a container to which the sensor unit is attached via welding or use of an adhesive to integrally attach the base portion of the flange unit to the wall of the container.

The base portion 2 is attached to a sensor retention portion 5 of the flange unit 2. The sensor retention portion 5 may have a cavity defined therein, which may be an aperture of the flange unit, that retains a substantial portion of a measurement unit 8. The external surface of the sensor retention portion 5 may be shaped to define one or more profiles 6. The profile may be any of a number of shaped structures such as a heel, a plurality of threads, at least one protuberance, at least one groove, at least one lip, a projection, or other shaped surface portion that may be sized and configured to engage with or matingly engage with and interlock with a clamping element 15 of a clamping mechanism 7.

The sensor retention portion 5 may be a sleeve that includes an internal channel that is in communication with an inlet, a mouth, a hole, or other aperture formed in the base portion 3 of the flange unit 2. The internal channel may be tapered or may have any of a number of shapes to define a space sized to receive and retain a measurement unit 8 that includes one or more measurement elements 12. In some embodiments, the internal surface of the sensor retention portion 5 that defines the internal channel may have one or more threads formed thereon or other profiles for engaging with or securing an attachment to the measurement unit 8. Additionally, one or more gaskets 13, such as annular sealing gaskets or O-rings, may be included within or attached to the sensor retention portion for engaging against the measurement unit 8 to provide a seal between the measurement unit and any container, such as a bag or other receptacle sized to retain a fluid such as a liquid or slurry to prevent liquid or material from passing through the seal and interfering with or damaging the sensor unit or desterilizing the contents of the container. For instance, at least one gasket may be positioned around the measurement unit 8 and then the measurement unit 8 may be inserted into the sensor receiving portion 5 to position each gasket and the measurement unit 8 in the flange unit 2.

The measurement unit is at least partially retained within the internal channel of the sensor retention portion 5. The measurement unit 8 may include one or more measuring elements 12 that are configured to measure, monitor, or determine a material characteristic of material retained within the container to which the sensor unit 1 is attached. An example of a measuring element is an electrode, optical spot, or other type of sensor or detector. For example, the measurement unit 8 may include an electrode 12a used to monitor the temperature of material within a container and an optical spot that includes a polymer disc embedded with flurophore to determine the oxygen or other gases dissolved in the material using the principle of fluorescence quenching Additionally, the measuring elements 12 may include a pH electrode 12b that includes pH glass for sensing the pH level of material within a container to which the sensor unit 1 is attached.

A tail end of the measurement unit 8 may be positionable through an aperture or hole formed in the base portion 3 of the flange unit 2 so that a portion of at least one measuring element is within a cavity defined by the container to which the sensor unit 1 is attached. For example, a measuring element 12 may be positioned so that it extends into the container at a depth of between about (e.g., ±10%) 1 millimeter to about 25 millimeters or 2 millimeters to 12 millimeters, or other desired dimension. Alternatively, that tail end of the measurement unit 8 may be positionable within the sensor retention portion 5 such that a terminal end of a measuring element is adjacent the flange unit 2 but not positioned within the container.

The opposite end of the measurement unit may be a head end 9 of the measurement unit. The head end 9 may be releasably connected to another portion of the measurement unit 8 or be an integral portion of the measurement unit 8. The head end 9 of the measurement unit may have a connector 10 that is used for connecting the measurement unit to a computer device. The connector 10 may provide a connection with wiring such as Ethernet cable or other wiring that transmits signals generated by the one or more measuring elements 12 to a computer, measurement processor device, or other computer device. Such wiring may also be used to provide electricity to the measurement unit 8 or measuring elements 12 to power the measuring elements 12. The connector 10 may alternatively connect the measurement unit directly to a transmitting device or network element that forwards any information sent via the connector to a particular computer device. Additionally, a computer device or a process control element connected to the measurement unit via the connector 10 and any intermediary connection elements (e.g. wiring, intermediary communication elements such as nodes, routers, etc.) may provide communication to the measurement unit 8 to provide control signals or other control information to the measurement unit or measuring elements 12. Such information may control the functioning of the measuring elements 12 or may be used to prompt the measurement unit 8 to transmit measurements or other data collected by one or more of the measuring elements. Of course, such control information may also be transmitted to the measurement unit 8 to adjust a rate at which data is collected by the measuring elements or adjust other functionality or activities conducted by the measurement unit 8 or measuring elements 12 of the measurement unit 8.

The head end 9 can, for example, be releasably attachable to another portion of the measurement unit that includes the one or more measuring elements 12 so that the head end 9 may be removed and reused when the measuring element portion of the measuring unit 8 is disposed of after a single use. Such a configuration is desirable for single-use applications of the sensor unit as it permits a transmission element of the sensor unit to at least be reused and thereby provides a cost savings.

It should be understood that each measuring element 12 may be an electrode or other mechanism that is configured to measure a particular characteristic of the material retained in the container, such as temperature, pH level, oxygen content, ozone content, conductivity, carbon dioxide content, carbon monoxide content, dissolved ion content, organic substance content, glucose content, lactate content, pyrovate content, or a combination of such characteristics. It should be understood that any content value such as oxygen content or organic substance content may be an absolute amount of such material or a percent composition content value. Additionally, it should be understood that each measuring element may be configured to directly monitor or measure such a parameter or provide a signal that is correlated with a particular material characteristic or material parameter or is otherwise derivable to determine such a measurement or parameter. Additional examples of measuring elements include electrochemical, amperometric, potentiometric, or optical sensors or detectors that measure at least one physical or chemical parameter of material within a container to which the sensor unit 1 is attached. The signal generated by such a measuring element 12, for example, may be transmitted via connector 10 to a central processing element such as a computer, process control center, or other computer device that processes the information transmitted via the connector 10 and any intermediate connection mechanism such as wiring, wireless signals, or network connection elements to derive or otherwise assess the measurement or other material characteristic or material parameter being monitored by that measuring element.

A middle portion of the measurement unit 8 or the head end 9 portion of the measurement unit may define a support 11 that is sized and configured to engage with a clamping mechanism 15 when the clamping mechanism 15 is attached to the sensor retention portion 5 of the flange unit 2.

The clamping mechanism 7 may have a body that defines a central opening sized to receive a portion of the measurement unit, such as the head end 9 portion of the measurement unit 8. The internal upper surface of the body may rest or engage the support 11 of the measurement unit when the clamping mechanism is attached to the flange unit 2. The body of the clamping mechanism may be structured to help enclose the measurement unit 8, or at least the measuring element 12 portions of the measurement unit 8.

The clamping mechanism 7 has one or more clamping elements 15 that are sized and configured to engage the one or more profiles 6 formed on the sensor retention portion 5. For example, the clamping elements 15 may include at least one inwardly directed projection 16 such as cap hooks, hook shaped projections, threads, at least one protuberance, or one or more projections of a different size or shape that are sized and configured to engage with the profile 6 of the sensor retention portion 5 to provide an attachment of the clamping mechanism 7 to the flange unit 2, which may function to sandwich or otherwise position and retain the measurement unit 8 between the clamping mechanism 7 and the flange unit 2. The clamping mechanism 7 may thereby ensure enclosure of most, if not all of the measurement unit 8. For instance, the clamping mechanism 7 may help ensure that the measuring elements 12 are enclosed by the clamping mechanism, container, and flange unit or just the clamping mechanism and flange unit to prevent desterilization of the measuring elements. The clamping mechanism 7 may also function to ensure attachment of the measurement unit 8 to the flange unit 2 by preventing the measurement unit 8 from moving away from the flange unit 2 or out of the inner channel of the sensor retention portion 5.

In exemplary embodiments, the clamping mechanism 7 may be a retainer cap that has a bottom cap surface that defines the opening for fitting over the sensor retention portion 5 and at least one profile 6. The top cap surface may also define an opening that receives the head end 9 portion of the measurement unit 8. The bottom cap surface or at least one internal wall of the cap may have a clamping element such as a cap hook that is configured to lock the retainer cap in place and secure the measurement unit 8 within the housing defined by the flange unit 2. For such embodiments, the measurement unit 8 or at least one of the measuring elements 12 may be considered a sensor and the flange unit may be considered a housing.

The clamping elements 15 of the clamping mechanism 7 may be configured so that the clamping mechanism 7 or clamping elements 15 of the clamping mechanism 7 provide a visual indication that indicates whether the sensor unit 1 was previously used before its application with a particular material positioned in a container to which the sensor unit 1 is attached or that provides a visual indication indicating the attachment of the measurement unit 8 to the flange unit 2 is not sufficiently secure or damages such that a leak or desterilization of material may occur when the sensor unit 1 is used. For example, the projections 16 of the clamping elements 15 may be geometrically shaped sand sized so that they provide an initial connection that secures the clamping mechanism to the sensor retention portion 5 of the flange unit 2. Due to the size, shape, and material of the projections 16 of the clamping elements 1, the clamping elements may have a predetermined breaking point that correlates with the clamping elements 15 being moved away from the at least one profile 6 after being engaged therewith for attaching the clamping mechanism to the sensor retention portion 5 of the flange unit.

The predetermined breaking point can, for example, be selected so that a bending or moving of the clamping elements 15 away from the profile 6 to remove the clamping mechanism 7 results in the clamping elements breaking sufficiently to visually indicate the breakage to a person that may visually inspect the clamping mechanism 7. For instance, the breaking may be a deformation of the clamping mechanism at a predetermined deformation point. The clamping mechanism 7 may be configured to that a portion of the clamping mechanism alters in color or otherwise provides a visual indication of such deformation when a force at or above the breaking threshold is applied to a clamping element 15 of the clamping mechanism 7. As another example, the breaking may be irreversible fracturing of the clamping elements. For instance, the inward projection 16 or other portion of a clamping element may break off upon experiencing a force at or above the breaking threshold. As another example, a portion of the clamping element or other portion of the clamping mechanism may undergo deformation that is visually indicated upon experiencing a force at or above the breaking threshold The clamping mechanism 7 can, for example, be sized and configured so that a mechanical tool is needed to try to remove the clamping elements 15 from the one or more profiles 6 to generate any removal and, as a result of the predetermined breaking point, breakage of the clamping elements 15.

It should be appreciated that an attempted or actual removal of the sensor unit to reuse at least the measuring elements 12 of the measurement unit 8 of the sensor unit 1 may also be visually indicated by the broken clamping mechanism 7 that may be generated as discussed herein. Such a visual indication can help easily indicate to a user via a visual check that a sensor unit is, for example, being improperly used a second time for a single use application.

The sensor unit 1 may be configured so that it can be sterilized. For instance, the sensor unit 1 may be gamma sterilized prior to attachment to a container. As another example, the sensor unit may be sterilized with a container after being attached to the container so that both the container and the sensor unit are sterilized at the same time using the same sterilization process.

In some alternative embodiments, the structure of the flange unit 2 of the sensor unit 1 may alternatively be configured as a disposable sensor port for a container that is ultimately not used for any measurements or as a sensor unit. Such a port may be configured with a sealing body that replaces the measurement unit device of the sensor unit. The sealing body may fit within the sensor retention portion of the flange unit so that the sensor retention portion functions as a sealing body retention portion. The sealing body may merely be a shaped structure that fits within the channel or other opening of the retention portion to provide a sealed attachment therein to serve as a liquid impermeable barrier to any fluid within a container. The sealing body may seal the port defined by the flange unit to prevent leakage of material and maintain the sterilization of material within the container. The clamping mechanism 7 may still be used to help enclose the sealing body or attach the sealing body in the retention portion of the flange unit. The clamping mechanism may also be configured to have a predetermined breakage point to help provide a visual indication of an attempted loosening or removal of the sealing body so that a visual indication can permit a person to detect a second use of the sealing body when it is configured for only a single use application or to proactively identify damage to the port or connection of the sealing body that could result in leakage of material.

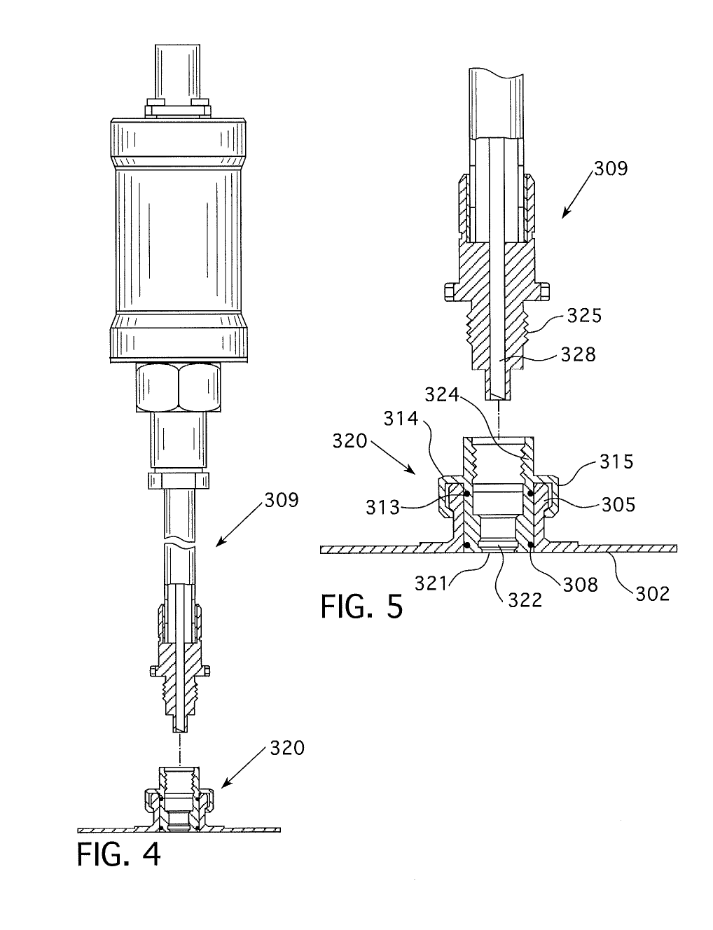

Referring to FIGS. 4-5, an exemplary sensor unit 320 may include a sensor head 309 that is shown partially in cross section. The sensor unit 320 includes a flange unit 302 and a measurement unit 308 arranged therein. The flange unit 302 may be composed of a polymeric material and be shaped and sized for attaching to an external surface of a container, such as a polymeric bag, via welding or an adhesive.

In this embodiment, a clamping mechanism 314 can be integral with the measurement unit 308 such that they form one unitary piece or structure. The clamping mechanism 314 includes clamping elements 315 that engage a profile 305 defined in a sensor retention portion of the flange unit 302, which functions to attach the measurement unit 308 to the flange unit 302.

The measurement unit 308 has a measuring element 321 that is an optical spot. The measuring element 321 includes a polymer disk that is embedded with flurophore and is configured to determine oxygen content or other dissolved gases using the principle of fluorescence quenching. The flurophore may be adapted to the parameter to be measured. The measuring element 321 is arranged in the measurement unit 308 so that in operation the measuring element is in contact with material positioned in a container to measure that material. A glass carrier 322 may be incorporated in the measurement unit 308 to protect the interior of the measurement unit from penetration of the material in the container that is being measured or monitored by the measuring element 321.

A head end portion 309 of the measurement unit 308 can be attached or may be releasably attachable to the measurement unit 308. The head end portion 309 includes an external thread 325 for engaging an internal thread 324 formed in a mid portion of the measurement unit 308. The head end 309 portion also includes a connector element 328 that includes wiring for facilitating the communication of output from the measuring element 321 to a process control element such as a work station or process control monitor station. The wiring may be, for example, an optical fiber or other wire suitable for facilitation communication. The connector element 328 may additionally provide a transmission means such as an optical element (e.g., fiber, lens and so forth) through which power such as radiation is directed to the measuring element to permit the measuring element to function to monitor at least one material characteristic of material within the container to which the sensor unit is attached.

It should be understood that the measurement unit 308 may be substantially composed of metal or a metal alloy that is biocompatible, such as stainless steel for example. The body of the measurement unit 308 and the clamping mechanism 314 can alternatively be made of a plastic material such as polyamide, polycarbonate, polyethylene, polyethersulphone, polypropylene, polytetrafluoroethylene, polyvinylchloride, cellulose acetate or ethylene vinyl acetate or other type of polymeric material.

It should also be appreciated that the sensor unit 320 may be configured so that the flange unit 302 is positioned in engagement with the external surface of the wall of a container or an internal surface of the wall of a container. If in engagement with the internal surface of the wall of a container, the flange unit 302 may include or may seat one or more gaskets 313, such as O-rings, that provide a more liquid impermeable seal between the flange unit 302 and wall of the container to which the sensor unit 320 is attached. If attached on the interior of the container wall, the removable sensor head portion may be removed and the container, flange unit 302 and measurement unit portion having the measuring element 321 may subsequently be disposed of or destroyed after being used one time if configured for single use reaction systems. As noted above, the removed head portion 309, however, may be saved for reusing with a new sensor unit of a different single use reaction system.

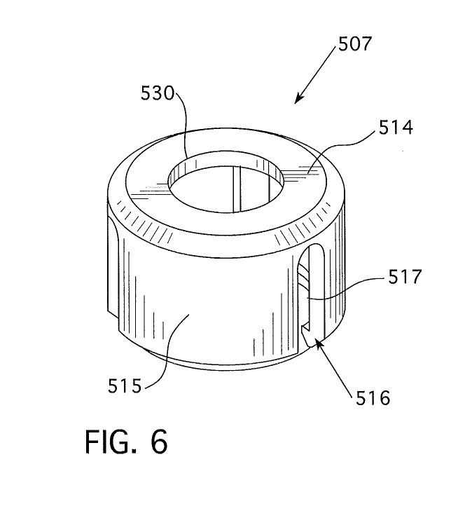

Referring to FIG. 6, a clamping mechanism 507 that may be used in connection with embodiments of the sensor unit includes a body 514 that defines a central opening 530 that includes a cavity and hole in communication with the cavity. It should be appreciated that the hole permits a portion of a head end of a measurement unit to extend therethrough or be inserted therein.

The clamping mechanism 507 may be structured either as an integral component that is a portion of a unitary structure incorporated within a portion of the measurement unit as may be appreciated with reference to the second embodiment discussed above or may be a separate component that is attachable to a flange unit as discussed above with reference to the exemplary embodiment shown in FIGS. 1-3. The body of the clamping mechanism may include a plurality of clamping elements 515 that include inwardly projecting protuberances or projections 516. Slots 517 or other spacing or apertures may be defined between different clamping elements 515.

The clamping elements 515 may be sized and shaped to break upon experiencing a predefined amount of force after the clamping elements are positioned into engagement with a profile defined on a portion of a flange unit so that a portion of the clamping element breaks away to provide a visual indication that the clamping element has been previously removed from a flange unit. Such an indication may provide an indication that a connection between the sensor unit and a container is damages that could lead to a desterilization of material within the container. In the event the sensor unit is designed such that the measuring unit of the sensor unit is for a single use application, the broken clamping element may also, or alternatively, indicate that the one or more measuring elements of the sensor unit have been previously used and are no longer appropriate for use in a subsequent application.

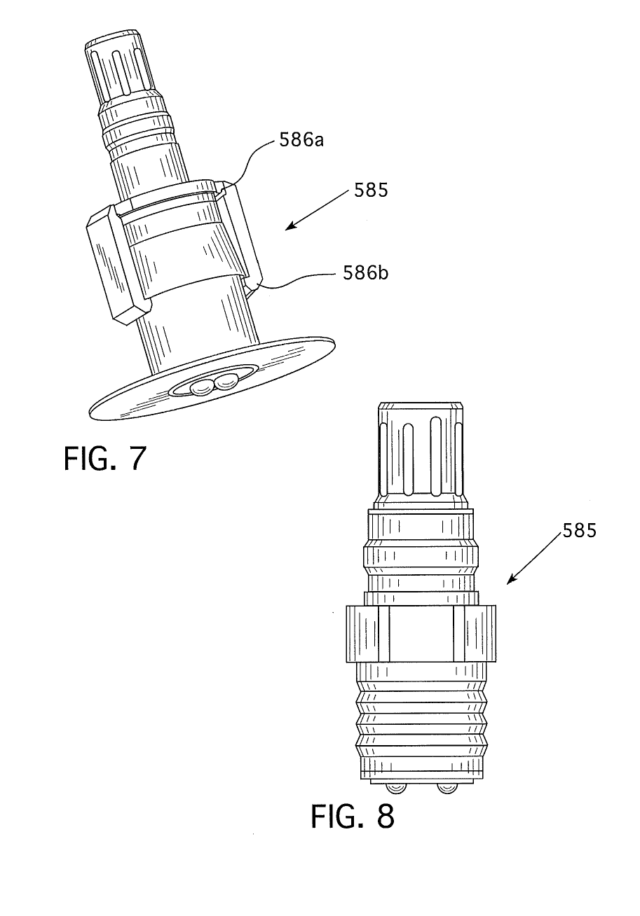

Referring to FIGS. 7 and 8, alternative exemplary sensor unit designs are illustrated having different structured clamping mechanisms 585 having different clamping elements. As may be appreciated by those of at least ordinary skill in the art, a number of other alternative designs in terms of shape and size of the different components of the sensor unit may also be made.

As may be seen in FIG. 7, a clamping mechanism 585 may be designed to have one or more portions 586a and 586b that deform or fracture from the clamping mechanism upon the clamping mechanism experiencing a predetermined amount of force or more than that force. Such a predetermined amount of force may be a breaking point amount of force. The experience of such force may be due to a person attempting to remove a clamping element from its engagement with a profile on a retention portion of the flange unit for example. The one or more portions of the clamping mechanism 585 may provide a visual indication of experiencing such force. For instance, the portion 586a may change color to indicate deformation that occurred as a result of experience such an amount of force or more than such an amount of force. As another example, portion 586b may fracture such that a portion of a clamping element away from the body of the clamping mechanism 585 or portion 586a may fracture so that the entire clamping element breaks away from the clamping mechanism.

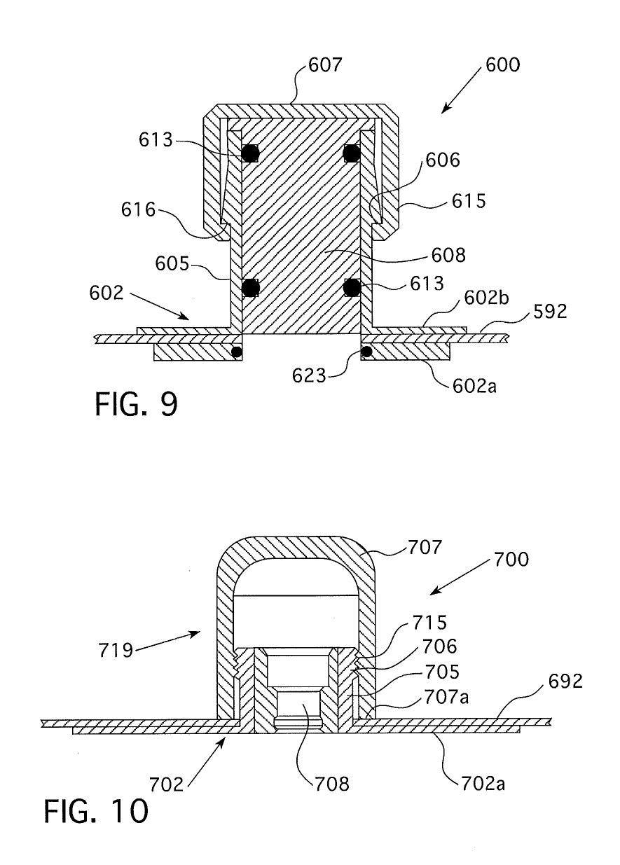

Referring to FIG. 9, a sensor unit may be configured so that the flange unit includes multiple separate components that are on separate sides of a container wall 592, such as a bag wall or bag reactor wall. The flange unit 602 of the sensor unit 600 may provide a bulkhead fitting for attachment to the wall 592 of the container. The flange unit 602 may include a base plate portion 602a that includes an annular gasket 623 adjacent an opening formed in the base plate portion 602a that is positioned on and adhered to or otherwise attached to the internal surface of the container wall 592. The base plate portion 602a may be considered an internal port plate for some embodiments.

The flange unit 602 may also include an external plate 602b that is positionable in alignment with the internal surface base plate portion 602a and is adhered in alignment with that internal base plate portion 602a so that an aperture formed in the external plate 602b aligns with the opening formed in the internal surface base plate portion 602a. The external plate 602b may be considered a port plate for some embodiments.

A sensor retention portion 605 may extend from the external plate portion 602b of the flange unit 602. A plurality of gaskets 613 may be positioned adjacent an internal chamber or channel formed in the flange unit for retaining a measurement unit 608 positionable within the channel adjacent and in engagement with the gaskets 613. The measurement unit 608 may include an outer portion that is shaped to have a profile to mate with and interlock with an outer surface of the sensor retention portion 605 to prevent the measurement unit 608 from being extended fully through the sensor retention portion 605. A clamping mechanism 607 that includes at least one clamping element 615 may be positioned over the measurement unit and the sensor retention portion 605 such that inwardly projecting ends 616 of the clamping elements 615 fit over and engage with a profile 606 such as a lip or ledge formed on the external surface of the sensor retention portion 605 to help secure the measurement unit 608 to the flange unit enclosed the measuring elements within the flange unit and the container.

The measurement unit 608 may include one or more measuring elements that are configured to monitor a condition of material within the container wall 592. The measurement unit 608 may include a wireless transceiver device configured to transmit data to a computer device and may also include a battery for powering the measurement unit 608. The measurement unit 608 may also include memory such as write-read memory, read only memory, or other types of non-transitory memory. The memory may be coupled or otherwise communicatively connected to each measuring element or there may be respective memory attached to a respective one of the measuring elements. The memory may store an identification of the measuring element or measuring elements to which it is coupled or otherwise communicatively connected with. The memory may also be configured to temporarily or permanently store measurements or signals relating to such measurements made by the one or more measuring elements to which it is connected.

In some contemplated embodiments, the sensor unit may alternatively be configured to provide a blind flange, or blind sensor port that does not include any measurement unit or measuring elements. Such a configuration may utilize a sealing body that is shaped similarly to the shape of the measurement unit to provide a sealing insertion within the opening of the sensor retention portion of the flange unit. For instance, the sealing body may be a structure having an external surface and a shape that mates with the opening defined in the retention portion of the flange unit and is receivable therein. One or more gaskets may be attached to the sealing body or may be positioned on the seating body to help the sealing body form a liquid impermeable barrier to material within the container to which the flange unit is attached. Such a use of the sealing body may permit unused ports of a standard bag or other standard container to be plugged by the sealing body to prevent material leakage or desterilization of material within the container.

In yet other embodiments, the sealing body structure may be replaced with tubing or a conduit that is positionable within the retention portion or attached to the retention portion of the flange unit so that material may flow from the container to another location via the conduit. The conduit may include a valve for controlling the flow of material or may include a valve that is moveable from a closed position to an open position to block the movement of material when closed and permit material to pass from the container into the conduit via the channel defined in the retention portion of the flange unit when in the open position.

Referring to FIG. 10, the sensor unit 700 is also configured so that the flange unit 702 of the sensor unit 700 provides a bulkhead fitting for attachment to a wall 692 of a container, such as a bag, vessel, or tube having walls composed of a polymeric material that is rigid or flexible. The flange unit 702 may be positionable on an inner surface of the wall 692 and include a sensor retention portion 705 that extends outwardly out of the container wall 692. One or more gaskets (not shown) may be positioned between the flange unit 702 and the inner surface of the wall 692 to provide a more liquid impermeable attachment between the internal surface of the wall 692 and the flange unit 702.

The sensor retention portion 705 may have a profile such as threads 706 formed thereon. The threads may mate with the clamping element 715 of a clamping mechanism 707 so that the clamping mechanism 707 may be rotated to screw the clamping mechanism 707 onto the flange unit 702 to help enclose and attach a measurement unit 708 positioned in the channel of the sensor retention portion 705. It should be appreciated that some embodiments of the clamping mechanism 707 may have a body 719 that includes a portion configured to be or function as a nut or bulkhead nut. In yet other embodiments, the body of the clamping mechanism may be a bulkhead nut.

The body 719 of the clamping mechanism 707 may also include a battery that is configured to power the measurement unit when the clamping mechanism 707 is tightly attached to the sensor retention portion 705. The body 719 of the clamping mechanism may also include a transmitter that is configured to connect to the measurement unit 708 and transmit data collected by the measurement unit 708 when the clamping mechanism 707 is attached to the sensor retention portion 705 via the threads 706 of the sensor retention portion and mating clamping mechanism 715, which may be threads that mate with the threads 706. It should be appreciated that a spacer such as a washer (not shown) could also be positioned between the innermost portion 707a of the clamping mechanism and the container wall 692 and base flange portion 702a of the flange unit 702. The transmitter may be a wired or wireless transceiver unit, for example.

The base flange portion 702a is, for example, composed of a polymeric material and is either welded or adhered to the internal surface of the wall 692 if the wall 692 is composed of a polymeric material. Of course, if the wall 692 is composed of metal, the base flange portion 702a may be, for example, composed of metal such as an alloy that is weldable to the wall 692 and be welded to the internal surface of that wall 692.

It should be understood that a number of variations to the sensor unit may be made. For instance, a sensor unit may utilize any combination of measuring elements within a measurement unit. As another example, the sensor unit may be shaped and sized to meet a design requirement for any of a number of different container sizes or to meet other design criteria a particular customer or end user may specify. As yet another example, any of the measuring elements of a measuring unit component of the sensor unit may extend into a container at any of a number of exemplary depths, such as 1 millimeter, 2 millimeters, 5 millimeters, 12 millimeters, 13 millimeters, 25 millimeters, or other depths or range of depths between 1-2 mm, 1-5 mm, 1-12 mm, 1-13, mm, 1-25 mm, 2-5 mm, 2-12 mm, 2-13 mm, or 2-25 mm or any other range combination thereof between 1 mm and 25 mm. In yet other embodiments, a measuring element may extend more than 25 mm into a container. Such a depth may depend on a design objective of the measuring element and the size of a container to which a sensor unit is to be attached.

It should also be appreciated that any of the above noted features of a sensor unit in any particular embodiment expressly discussed herein may be combined with other features or elements of other embodiments except when such a combination would be mutually exclusive or otherwise incompatible therewith as may be appreciated by those of at least ordinary skill in the art.

While certain present preferred embodiments of sensor units, disposable sensor ports, disposable ports, and methods of making and using the same have been shown and described above, it is to be distinctly understood that the invention is not limited thereto but may be otherwise variously embodied and practiced within the scope of the following claims. Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1-8. (canceled)

9. A sensor unit sized and configured for attachment to a container, comprising:
a flange unit having an aperture, a base portion and a sensor retention portion, the base portion of the flange unit being attachable to the container, the sensor retention portion of the flange unit having at least one profile formed thereon;
a measurement unit at least partially retained within the sensor retention portion of the flange unit, the measurement unit having at least one measuring element;
a clamping mechanism having an opening for receiving a portion of the measurement unit, the clamping mechanism having at least one clamping element sized to engage with at least one of the at least one profile of the sensor retention portion of the flange unit such that the clamping mechanism ensures at least one of: (i) attachment of the measurement unit to the flange unit and (ii) enclosure of the at least one measuring element within at least one of the sensor unit and the container;
the at least one clamping element having one of:
(a) a predetermined deformation point that changes in color at the predetermined deformation point when the at least one clamping element is loosened or removed from the at least one profile of the sensor retention portion of the flange unit, and
(b) a predetermined breaking point at which the at least one clamping element is irreversibly fractured when loosened or removed from the at least one profile of the sensor retention portion of the flange unit; and
deformation at the predetermined deformation point or fracture at the predetermined breaking point being visible to visually indicating a loosening or removal of the at least one clamping element from the at least one profile.

10. The sensor unit of claim 9, in combination with a container, wherein the container is a bag of a reactor bag and the at least one measuring element is a single use measuring element for a single use reaction system.

11. The sensor unit of claim 9, wherein the sensor retention portion of the flange unit comprises:
at least one gasket attached therein such that the at least one gasket engages the measurement unit.

12. The sensor unit of claim 11, wherein the at least one gasket is at least one O-ring.

13. The sensor unit of claim 9, wherein the at least one measuring element measures, monitors or determines at least one of oxygen content, pH value, temperature, conductivity, carbon dioxide content, carbon monoxide content, dissolved ion content, and organic substance content.

14. The sensor unit of claim 13, wherein the organic substance content is glucose content, lactate content or pyrovate content.

15. The sensor unit of claim 9, wherein the base portion of the flange unit is configured for bonding to a wall of the container to integrally attach the flange unit to a container and wherein the aperture of the flange unit defines a port through which the measurement unit is adjacent and wherein material stored within the container is measured via the at least one measuring element of the measurement unit.

16. The sensor unit of claim 9, wherein the at least one profile of the sensor retention unit is threaded and wherein the clamping mechanism is a body and the at least one clamping element is comprised of threads formed in the body adjacent an opening that mates with threads of the sensor retention unit such that rotation of the clamping mechanism in a first direction will tighten the clamping mechanism against the sensor retention unit to ensure enclosure of the at least one measuring element within the sensor unit and a container or within the sensor unit.

17. The sensor unit of claim 9, wherein the measurement unit has threads formed thereon to mate with internal threads formed in the sensor retention portion of the flange unit to attach the measurement unit to the flange unit; and
wherein the at least one profile of the sensor retention unit is external threads, the clamping mechanism is a body and the at least one clamping element includes threads formed in the body that engage with and mate with the external threads such that rotation of the clamping mechanism in a first direction will tighten the clamping mechanism against the flange unit.

18. The sensor unit of claim 9, wherein the clamping mechanism is configured for removal with a specified mechanical tool when the at least one clamping element engages the at least one profile to fracture the at least one clamping element at the breaking point.

19. The sensor unit of claim 9, wherein the at least one clamping element is comprised of a plurality of clamping elements adjacent at least one slot defined by the clamping mechanism, each of the clamping elements having a projection that matingly engages with the at least one profile of the sensor retention portion of the flange unit.

20. The sensor unit of claim 19, wherein the at least one profile of the sensor retention portion of the flange unit is a lip or a protuberance.

21. A disposable port sized and configured for attachment to a container, comprising:
a flange unit having an aperture, a base portion and a retention portion, the base portion of the flange unit being attachable to the container, the retention portion of the flange unit having at least one profile formed thereon;
a clamping mechanism, the clamping mechanism having at least one clamping element sized to engage with at least one of the at least one profile of the retention portion of the flange unit such that the clamping mechanism ensures at least one of: (i) attachment of a device to the flange unit and (ii) enclosure of the device within at least one of the disposable port and the container;
the at least one clamping element having one of:
(a) a predetermined deformation point that changes in color at the predetermined deformation point when the at least one clamping element is loosened or removed from the at least one profile of the retention portion of the flange unit, and
(b) a predetermined breaking point at which the at least one clamping element is irreversibly fractured when loosened or removed from the at least one profile of the retention portion of the flange unit; and
the predetermined deformation point or the predetermined breaking point visually indicating a loosening or removal of the at least one clamping element from the at least one profile.

22. The disposable port of claim 21 wherein the device is a sealing body shaped and sized to fit within the retention portion of the flange unit to provide a sealing attachment therein to prevent material from passing through the sensor port.

23. The disposable port of claim 21 wherein the device is a measurement unit having at least one measuring element and the body is positioned at least partially in the retention portion of the flange unit.

24. The disposable port of claim 23, wherein the clamping mechanism is configured for removal with a specified mechanical tool when the at least one clamping element engages the at least one profile so that the tool actuates fracture of the at least one clamping element when the at least one clamping element is removed from the at least one profile via the tool.

25. The disposable port of claim 21, wherein the at least one clamping element has the predetermined breaking point.

26. The disposable port of claim 21, wherein the at least one clamping element has the predetermined deformation point.

27. The disposable port of claim 21, wherein the at least one clamping element has the predetermined deformation point and wherein the at least one clamping element is comprised of a plurality of clamping elements adjacent at least one slot defined by the clamping mechanism, each of the clamping elements having a projection that matingly engages with the at least one profile of the retention portion of the flange unit.

28. The disposable port of claim 21 wherein the flange unit is an assembly wherein the base portion is a first port plate positionable on one of an interior surface of a wall of the container and an exterior surface of a wall of the container.

29-30. (canceled)

31. The disposable port of claim 27, wherein the at least one profile of the retention portion of the flange unit is a lip or a protuberance

32. The disposable port of claim 21, wherein the at least one clamping element has the predetermined breakage point and wherein the at least one clamping element is comprised of a plurality of clamping elements adjacent at least one slot, each of the clamping elements having a projection that matingly engages with the at least one profile of the retention portion of the flange unit.

33. The disposable port of claim 32, wherein the at least one profile of the retention portion of the flange unit is a lip or a protuberance.

34. The disposable port of claim 21, wherein the flange unit and the clamping mechanism are sterilized after attachment to the container.

35. The sensor unit of claim 9 wherein the measurement unit is sterilized after the sensor unit is attached to the container, the at least one measuring element extending into the container when the sensor unit is attached to the container.
